(19) United States
(12) Patent Application Publication
(10) Pub. No.: US 2012/0327523 A1
(43) Pub. Date: Dec. 27, 2012

(54) OFFSET CONCENTRATOR OPTIC FOR CONCENTRATED PHOTOVOLTAIC SYSTEMS

(76) Inventor: Andrew Tomlinson, Morpeth (GB)

(21) Appl. No.: 13/511,041

(22) PCT Filed: Nov. 23, 2010
(86) PCT No.: PCT/GB10/51943

§ 371 Date: Aug. 16, 2012

(30) Foreign Application Priority Data
Nov. 23, 2009 (GB) 0920422.3

(51) Int. Cl. G02B 5/04; G02B 3/00

(52) U.S. Cl. 359/737

(57) ABSTRACT

A concentrated photovoltaic (CPV) system for solar power generation incorporating an array of receiving elements in a panel with optical receiving components designed to accept light from an angle offset from the normal optical axis of the placement of the panel. The offset angle is approximately equal to the difference in the mean position of the sun, and the installed angle of the panel thereby enabling the elements to effectively point directly at the sun even if the angle of the sun is outside the limited angular rotation of the solar tracking system.

This invention relates to optics applicable to concentrated photovoltaic systems.

Photovoltaic (PV) systems are known to be expensive and can take many years to pay back their initial cost. Companies that specialise in specifying large scale photovoltaic installations are experts in evaluating the trade-offs between different configurations in order to make the most profitable installations possible.

It is common practice to install PV panels onto a frame that inclines the panel approximately according to latitude. The panel is therefore perpendicular to the average direction of the sun when it is above the horizon. This ensures that the maximum amount of incident power is collected on a fixed area over the course of a year.

This approach has a significant practical disadvantage for rooftop installations. Inclining the panel so that it is not parallel to the rooftop means that it presents a greater cross section to winds from certain directions, thereby increasing the maximum loads imposed on the building. For some buildings, the roof structure may only be able to withstand a limited wind load and hence this can be a limiting factor for photovoltaic installations.

Panels that are parallel to the roof are also more aesthetically appealing.

Concentrated Photovoltaic (CPV) systems, especially High Concentration PV systems (HCPV) are a promising method to reduce the cost of PV systems. The principle of CPV is to focus or concentrate direct sunlight onto a small PV cell using a lens or mirror or other optical design. Lenses/mirrors can be made more cheaply than photovoltaic materials, so there is a potential cost saving using this approach.

The operational performance of all HCPV systems requires accurate alignment of the focussing optic and PV cell with the sun's position in the sky throughout the day and throughout the year. Most HCPV systems employ a mechanical motion system to rotate, and thereby, track the sun with the combined focussing optic and PV cell. The cost of an accurate, reliable, motion system normally represents a significant proportion of the overall cost for a HCPV system.

WO2006/138619A2 discloses an idea for a concentrator system that uses a fixed frame, but has many small rotating concentrator elements within it. The panel can be mounted parallel to the roof, and the elements within the fixed panel rotate to track the apparent motion of the sun. An alternative approach, as suggested in WO2009/063231, also uses a fixed panel, but includes a larger number of rotating elements. This approach is an attempt to reduce the cost of the tracking or motion system.

The approach in WO2009/063231 has an important technical limitation. The maximum rotation of the elements in the array from their central position is limited to less than 90 degrees. This angular limitation is not serious if the panel is installed at the angle of the average seasonal mid-day solar position. However, if the panel is not inclined at this angle, then a motion system such as the one described in WO2009/063231 will only be able to point the elements directly at the sun for a greatly reduced proportion of the potential sunlight hours each year. This can reduce the energy yield of the system to the point where it is not economically viable.

According to the present invention there is provided a concentrated photovoltaic (CPV) system for solar power generation that incorporates an array of receiving elements in a panel with optical receiving components designed to accept light from an angle offset from the normal optical axis of the panel. The offset angle is approximately equal to the difference in the mean position of the sun, and the installed angle of the panel thereby enabling the elements to effectively point directly at the sun even if the angle of the sun is outside the limited angular rotation of the solar tracking system.

A specific embodiment of the invention will now be described by way of example with reference to the accompanying drawings in which:

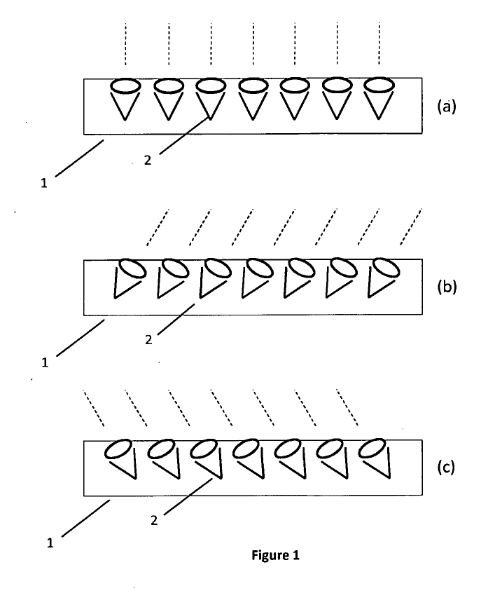

FIG. 1 illustrates a fixed frame CPV system with many small rotating elements designed to track the sun:

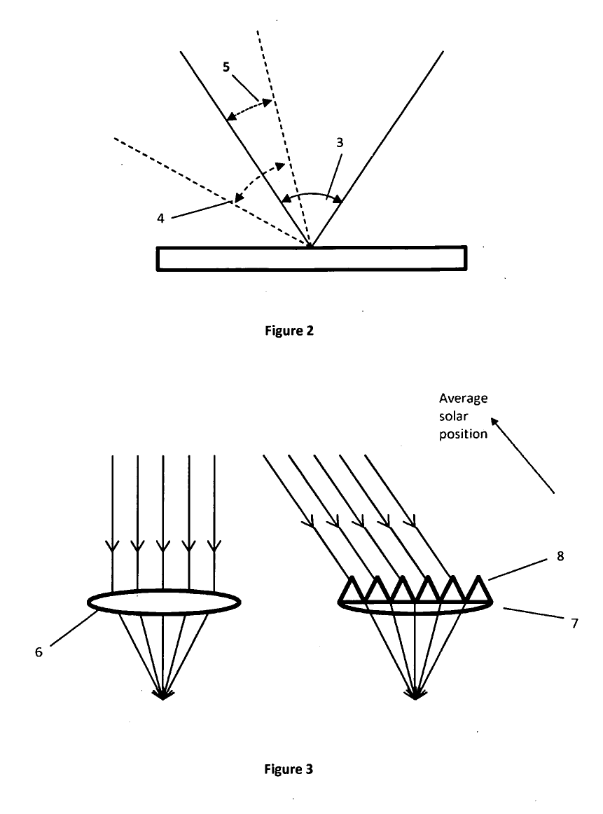

FIG. 2 illustrates the angular range of rotation of the elements in comparison with the angular seasonal position of the sun;

FIG. 3 illustrates the focusing of incident light with regular optics and offset optics;

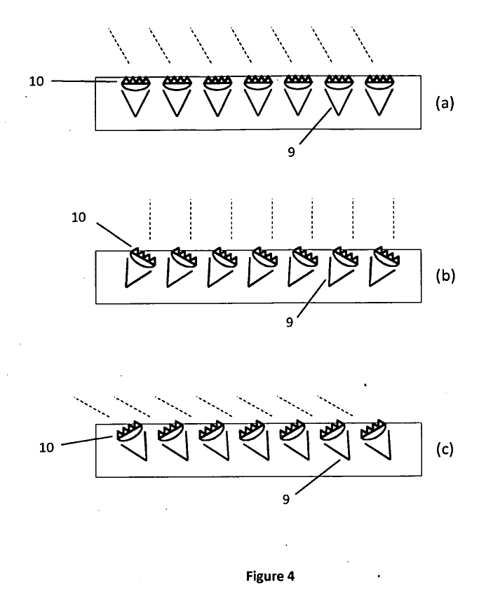

FIG. 4 illustrates a fixed frame CPV system with many small rotating elements designed to track the sun that incorporate offset optics;

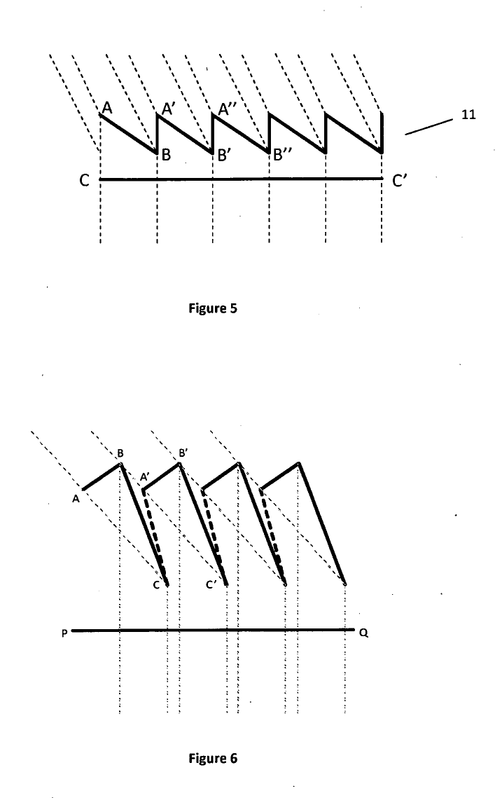

FIG. 5 illustrates a cross section close-up view of a simple Fresnel prism structure used to achieve the offset optics capability; and

FIG. 6 illustrates a cross section close-up view of an enhanced structure used to achieve the offset optics capability.

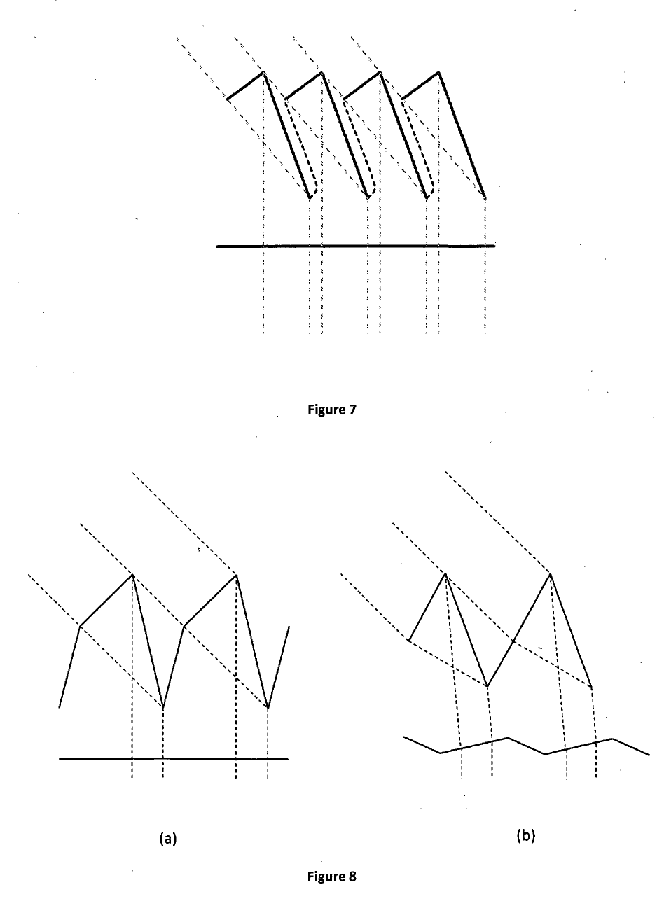

FIG. 7 illustrates the same cross section as FIG. 6, but with a different shape for the non-critical cross section close-up view of an enhanced structure used to achieve the offset optics capability.

Referring to the drawings limited solar tracking systems are illustrated in FIG. 1. In this depiction, a fixed frame 1, shown as a rectangle, encloses many small rotating elements 2. Each rotating element includes a focussing lens, and a photovoltaic cell. Elements can be in the central position (a), or at the two extremes of motion (b) and (c). When the sun is within the range of angles that the elements can point to, the system is able to gather energy effectively.

FIG. 2 FIG. 2 shows the angular range of the elements within the panel 3. The range of angles to the sun due to seasonal variations is shown by the dashed lines 4. It is immediately apparent, that the two ranges only overlap over the range of angles indicated by the dotted arc 5. Therefore, the concentrator system will not be able to produce power when the sun is outside of this range, which corresponds to a large fraction of the year.

A support frame could be used to incline the panel, but the disadvantages of support frames have already been discussed.

The invention that is the subject of this patent conveniently makes it possible to use a panel based on a tracker with limited steering range to be used in a predetermined orientation while greatly reducing the potential loss due to the limited steering range. Desirable features of the solution are that it does not sacrifice the energy gathering potential of the system, and that it keeps costs to a minimum.

The aim of this invention is to make a high-concentration concentrator system that may use a mechanical tracking system with limited range of angular motion, that can be mounted at a fixed arbitrary angle, and collect as much energy from the sun as possible over the course of a day/year.

It is proposed that a new optical element is included in the system, which deflects the light. Additional benefits are achieved when the element both deflects and focuses the light. The new optical element can be non-symmetrical and include in the first optical surface a means for deflecting the incoming radiation to the normal direction to the element. Ideally, the deflection is designed to accept light from an angle offset from the normal optical axis by an angle approximately equal to the difference in the mean position of the sun, and the installed angle of the panel.

In a first aspect of the invention there is therefore provided a light concentrator comprising:
a primary optical element (7) that has an optical axis
a frame (1) onto which the primary optical element is mounted
wherein the frame extends in a plane substantially perpendicular to the optical axis;
wherein the primary optical element is configured to rotate around an axis perpendicular to its optical axis; and further comprising a deflection component (8, 10) configured to enable incident light to be collected from angles of incidence in excess of the first angle.

The deflection component of the light concentrator preferably has translational symmetry and more preferably is further configured to focus light incident on it. The deflection component is ideally provided on a first surface of the primary optical element. In the most preferred aspect the deflection component is a Fresnel prism which may be arranged to have an entrance normal to the input direction and a surface where total internal reflection is used to deflect the light by the required angle. It is also preferred if the deflection component captures light from the whole area of the incident beam (FIG. 6)

The light concentrator may comprise a second optical element and may preferably comprise a plurality of primary optical elements, each mounted on the frame.

In a further aspect of the invention there is provided a solar concentrator system comprising two or more light concentrators as described above.

In a further aspect of the invention there is provided a solar photovoltaic concentrator system with an array of receiving elements accepting light from an angle offset from the normal optical axis by an angle approximately equal to the difference in the mean position of the sun, and the installed angle of the panel. It is a preferred feature wherein the offset angle is approximately equal to the angular difference between a vector normal to the surface of the panel, and the position of the sun at solar noon on the equinox for that location. It is further preferred wherein the concentrator system includes a concentrating optical elements possessing a top surface made from a Fresnel prism structure for offsetting the incident light more particularly wherein the solar photovoltaic concentrator system includes Fresnel structures specifically eliminating angular surface discontinuity losses corresponding to light incident at the desired offset angle.

The basic objective is shown in FIG. 3. On the left, a conventional lens 6 is used to concentrate light from directly above. On the right, a different optical element is shown 7, which has a feature on its top surface 8, marked in the drawing as a series of triangles, that deflect the light from the vertical, and may also provide some focussing function. It is important to note that the triangles shown to represent the position of the light deflecting structure 8 are not a representation of a realistic structure for this purpose. The deflection of the light by this feature 8 compensates for the difference between the panel's actual orientation and the average position of the sun.

A schematic of the final system is shown in FIG. 4 where every element of the array 9 includes a deflection component 10 as the first optical surface to allow the system to gather light from a range of directions not centred on the normal direction of the panel.

Inclusion of the light-deflecting feature on the first functional optical surface(s) has several advantages. Firstly, in manufacture only one aspect of the system changes as the system is manufactured for different offset angles. This makes it possible to only change one component in the whole system to make it suitable for different latitudes.

Secondly, this is an important advantage optically as it is sometimes impossible to make high performance optical components at low cost that function efficiently over a wide range of input angles.

The beam deflection component could be made from a simple Fresnel prism structure 11 as depicted in FIG. 5. Light is refracted at surface A-B, (or A′-B′ etc). This simple structure provides suitable beam deflection at the bottom surface C-C′ for the light incident on the surfaces A-B, A′-B′, etc. However, this system suffers from extra loss due to rays that strike the side walls of the structure, for example rays that strike B-A′ (or B′-A″ etc) are not deflected at the same angle. The unavoidable optical loss of this structure is significant at larger deflection angles.

A better structure for the first optical surface in the system is shown in cross section in FIG. 6. The figure shows a cross section on a component made from an optically transparent material with top surface, defined A-B-C-A′-B′. . . and the bottom surface P-Q. The profile of the top section has translational symmetry, not circular symmetry. P-Q is shown in this example as a flat surface, but in reality it could be a convex lens, a Fresnel lens of a total-internal-reflection lens such as that described in U.S. Pat. No. 4,337,759 or any other appropriate concentrating system. It is possible to make structures of the type shown in FIG. 6 so that the light passes through both the top and bottom surfaces normally. If different wavelengths are travelling in slightly different directions after the deflection component, it limits how tightly the light can be focussed in the next step of the system. The deflection component having translational symmetry therefore has the advantage that there is no chromatic aberration in the system

The shape of the repetitive representation of the surface depicted by C-A′ is not critical in this design so long as it does not intercept any of the construction lines shown in the figure (either solid or dashed). Making the vertex at C (and C′, C″ etc) less acute makes it possible to manufacture a mould using a milling machine, possibly fitted with a diamond tipped tool. A surface with an alternative form in the section C-A′ is shown in FIG. 7. While the structure shown in FIG. 7 performs the same function as the one in FIG. 6, this alternative shape may be easier to manufacture.

Construction lines in this example are shown on the drawing, showing rays of light incident at approximately 40 degrees to the vertical, which emerge from the bottom surface vertically.

It is possible that the surface P-Q could be a surface which partially or completely focuses or concentrates light. The deflecting element, which is the subject of this invention would in that case be a feature on a optical component that would perform both deflecting and concentrating functions. Note concentrators are sometimes composed of more than one optical element, and it is possible that the deflection feature would be included only the first concentrating element of the optical system. The current invention uses a lens to focus light arriving from a small range of angles onto a small cell. One of the purposes of a concentrator system of the present invention is reducing the amount of cell area required, thus focussing the light onto the smallest possible aperture.

It is also possible to make the structure so that there is a small amount of refraction at the surface A-B, and at surface P-Q by designing the structure so that the incident rays are not perpendicular to these surfaces, which can be useful in reducing the required depth of the structure for a minimal performance penalty. Use of a combination of refraction and total internal reflection is shown in FIG. 8.

It is also possible to make deflecting designs where structures similar to the one shown on the top surface of the structures in FIGS. 5 and 6 would be on both the top and bottom surfaces of the element.

A more complicated top surface to the optical element could be designed to include a degree of focussing from the front surface and/or an application of an optical thin film to reduce reflections and increase the power generation capability of the system.

In each of the designs, it is possible to use both the top and bottom surfaces to provide the complete optical function.

More advanced designs using more sophisticated optical designs, aspheric lens forms and non-imaging techniques could be applied to the designs discussed.

It is noted that it is common practice to include an anti-reflection coating, protective coating or anti-dirt coating on optical surfaces.

The component may be enclosed within a sealed case to prevent condensation or dirt.

The structure can be manufactured by injection moulding, applying a setting/curing material as a film onto an existing sheet, etching or embossing techniques.

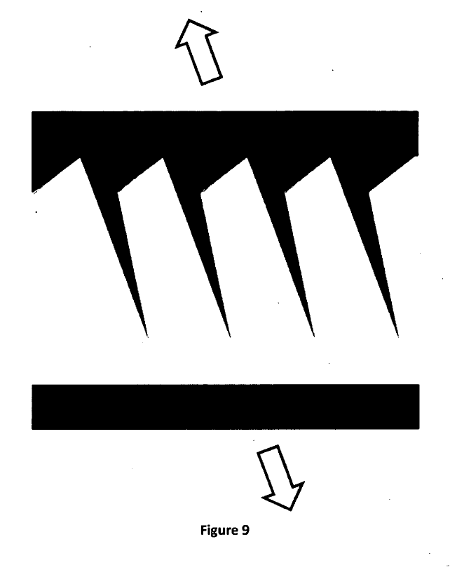

In the case where the component is purely a deflection component and hence has translational rather than rotational symmetry, or for some designs where focussing is included, it can be manufactured using a simple open and shut mould tool without side actions. The mould tool and the direction of motion of the two halves of the mould are shown in FIG. 9. The structure could be made from any transparent material or combination of materials—appropriate choices include but are not restricted to transparent polymers such as PMMA or Polycarbonate, glasses, and silicone on glass.

1. A light concentrator comprising:
a primary optical element (7) that has an optical axis
a frame (1) onto which the primary optical element is mounted
wherein the frame extends in a plane substantially perpendicular to the optical axis;
wherein the primary optical element is configured to rotate around an axis perpendicular to its optical axis; and
further comprising a deflection component (8, 10) provided on a first surface of the primary optical element and configured to enable incident light to be collected from angles of incidence in excess of the first angle.

2. A light concentrator according to claim 1, wherein the deflection component has translational symmetry.

3. A light concentrator according to claim 2, wherein the deflection component is further configured to focus light incident on it.

4. (canceled)

5. A light concentrator according to claim 1, wherein the deflection component is a Fresnel prism.

6. A light concentrator according to claim 1 further comprising a second optical element.

7. A light concentrator according to claim 1 further comprising a plurality of primary optical elements, each mounted on the frame.

8. A solar concentrator system comprising two or more light concentrators according to claim 1.
